(19) United States
(12) Patent Application Publication
(10) Pub. No.: US 2007/0199586 A1
(43) Pub. Date: Aug. 30, 2007

(54) Lock assembly of foldable walker

(76) Inventor: Juei-Chuan Cheng, Taichung (TW)

Correspondence Address: JUEI-CHUAN CHENG, P.O. BOX 219, TAICHUNG, TW

(21) Appl. No.: 11/360,431

(22) Filed: Feb. 24, 2006

(51) Int. Cl. A61H 3/00; A61H 3/02

(52) U.S. Cl. 135/67; 280/87.021

(57) ABSTRACT

A lock assembly is disclosed for use with a foldable walker. The lock assembly includes a lock pin movable between a first position in which the corresponding side member is held in a locked unfolded state and a second position in which the side member is in an unlocked folded state. A lock plate extends transversely to the longitudinal axis of the corresponding side member. The lock plate includes an aperture adapted to receive a locking end of the lock pin when the pin is in its first position and a guide trough limiting the side members to rotate relatively in a certain angles. A lever is connected to the lock pin such that when the lever is pushed down, the lock pin is moved from its first position to its second position and holds in the second position to permit rotation of the corresponding side member to its folded state.

### FIELD OF THE INVENTION

This invention relates generally to a lock assembly, and more particularly to a lock assembly for use with a foldable walker.

### BACKGROUND OF THE INVENTION

The conventional invention patented to Diamond, U.S. Pat. No. 6,886,575 B2, includes a lock pin movable between a first position in which the corresponding side member is held in a locked, unfolded state and a second position in which the side member is in a folded state. A lock plate extends transversely to the longitudinal axis of the corresponding side member, and includes an aperture adapted to receive a locking end of the lock pin when the pin is in its first position. A lever is coupled to the lock pin such that when the lever is pivoted by upwardly applied pressure, the lock pin is moved from its first position to its second position to permit rotation of the corresponding side member to its folded state.

The above art have the drawbacks as following. First, the lock pin corresponds with a spring, which force the pin in the first position as in an unfolded state. Therefore, an invalid have to hold the lever upward to unlock and fold the walker. It is inconvenient for an invalid to operate when he/she is in sitting position. Second, a gap between the lever and the side frame, which allows the lever to shift, is easy to accumulate the dust and difficult to clean. Through a certain time, the accumulated dust may cause the functional disability of the lever or the pin.

### SUMMARY OF THE INVENTION

An embodiment of the present invention overcome the above-described shortcomings of prior art and satisfy a significant need for a foldable walker that is relatively easy to configure between folded and unfolded positions by invalids. According to an exemplary embodiment of the present invention, a lock assembly is provided for use with a cylindrical member concentrically and rotatably mounted in a tubular member.

The lock assembly includes a lock pin positioned parallel to a longitudinal axis of each of the two members and located external thereto. The lock pin is movable between a first position in which the two members are held in a locked state and a second position in which the members are in an unlocked state so that the two members are able to rotate relatively to each other. A lock plate is secured to one of the two members and extends transversely to the longitudinal axis thereof. The lock plate has an aperture adapted to receive a locking end of the lock pin when the pin is in the first position. A lever assembly is provided for moving the lock pin from its first position to its second position to permit rotation of the cylindrical member in relation to the tubular member.

This lever assembly, shaping in an “L”, comprises one end operatively connected to the lock pin, the other end formed a force-applying handle, and the middle flat salient pivoted the lever. As pushing down the handle, lock pin will move up and hold in unlocked position thereby allowing the two members to be movable relative to each other.

Objects and advantages of the present invention will become apparent from reading the following description of the invention wherein reference is made to the accompanying drawings.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1a is a perspective view of a foldable walker;

FIG. 2 is an enlarged exploded perspective view of the lock assembly portion for the foldable walker of FIG. 1;

FIG. 3 is a perspective view of the lock assembly as shown in FIG. 2;

FIG. 4 is a crossing view of the lock assembly as a lock pin in first position;

FIG. 5 is a crossing view of the lock assembly as a lock pin in second position;

FIG. 6 is a perspective view of a foldable walker in fold position as shown in FIG. 1.

### DETAILED DESCRIPTION OF THE PREFERRED EMBODIMENT

The present invention will now be described more fully hereinafter with reference to the accompanying drawings in which an exemplary embodiment of the invention is shown. This invention may, however, be embodied in many different forms and should not be construed as being limited to the embodiment set forth herein. Rather, the embodiment is provided so that this disclosure will be thorough and complete, and will fully convey the scope of the invention to those skilled in the art.

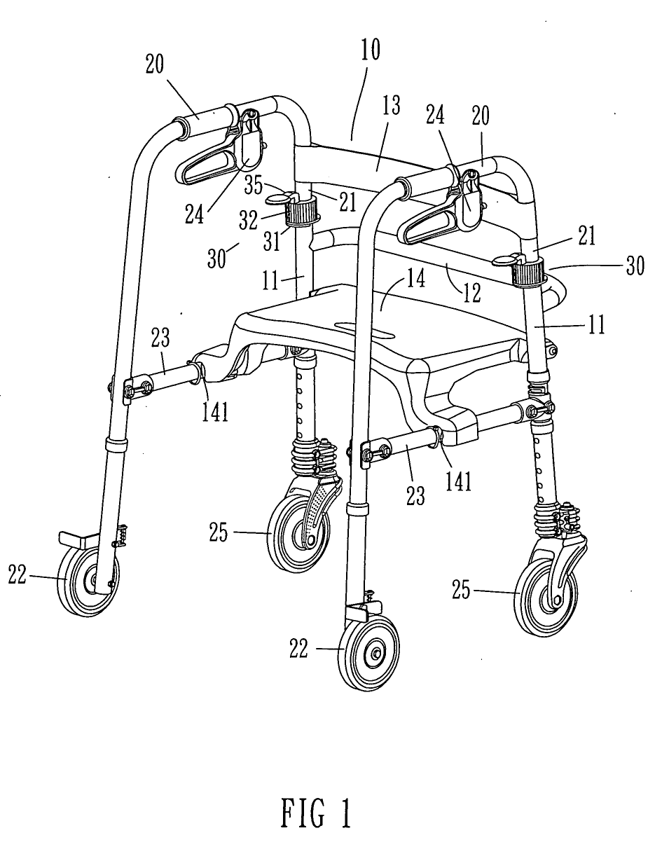

As shown in FIG. 1, a foldable walker 10 comprises two side frames 20, a cross brace 12, two lock assemblies 30, a foldable seat 14, a back belt 13, and four wheels 22, 25. The cross brace 12 comprises a cross bar connected to a pair of substantially vertical end sleeves 11 which snugly embrace and surround intermediate portions of the front legs 21 of side frames 20, respectively.

The side frame 20 comprises an “n” shaped frame which forms a front leg 21 and a rear leg, a break handle 24 which control the rear wheel 22 to roll or break, a side brace 23 set between the intermediate portions of the front and back legs, and two wheels 22, 25 on the ends of two legs.

The foldable seat 14 pivotally connects on sleeves 11 and two extended troughs 141 of the seat 14 may hold on two side braces 23 of the side frames 20 when the side frames 20 are opened. The seat can be lifted up and forward when it don't need to use or when the walker is folded for storage. The back belt 13 is connected on upper portion of the front legs 21 for a user's back to rest when a user sits on the seat 14.

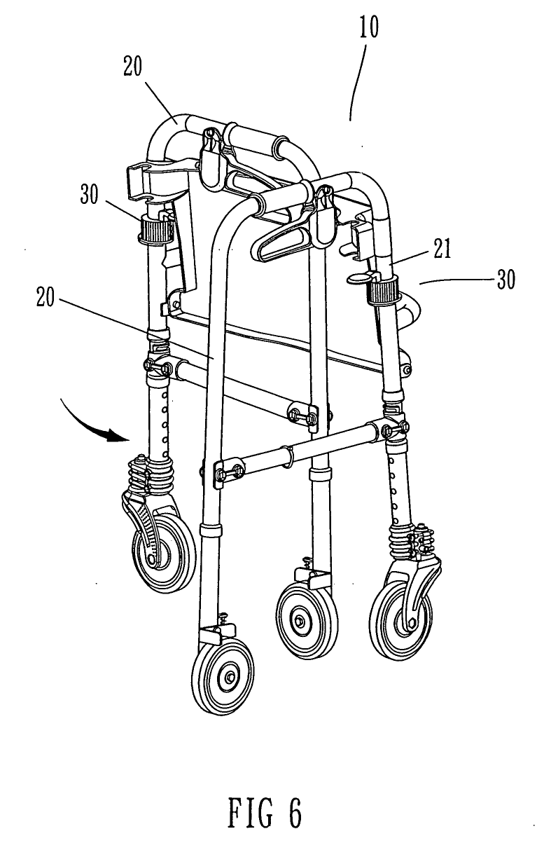

Accordingly, a lock assembly 30 cooperates with each of the front legs 21 and its associated end sleeves 11 to lock the walker 10 in its operative position, as shown in FIG. 1 for side frame 20, or to enable the walker to be relatively easily folded into its folded position, as shown in FIG. 6 for side frame 20.

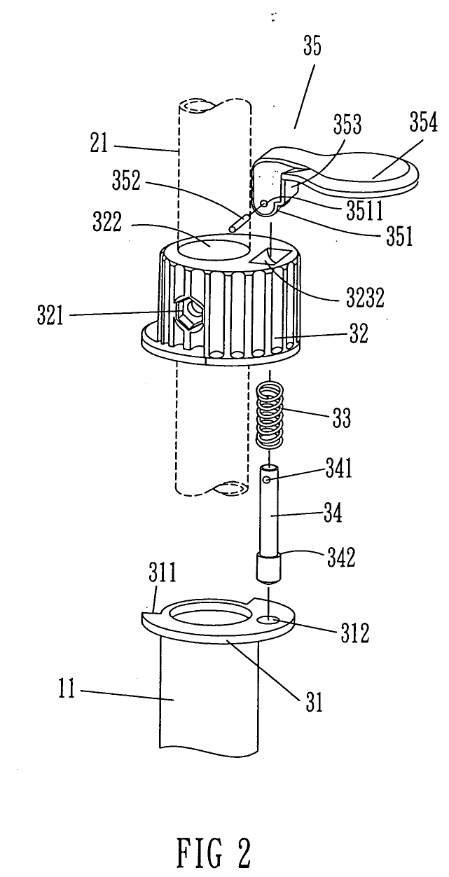

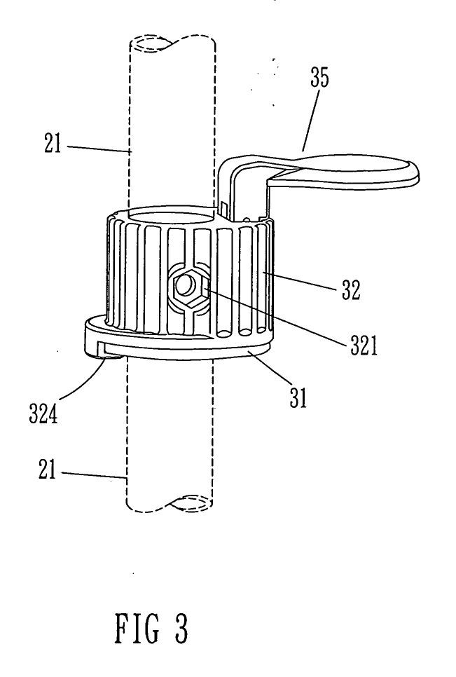

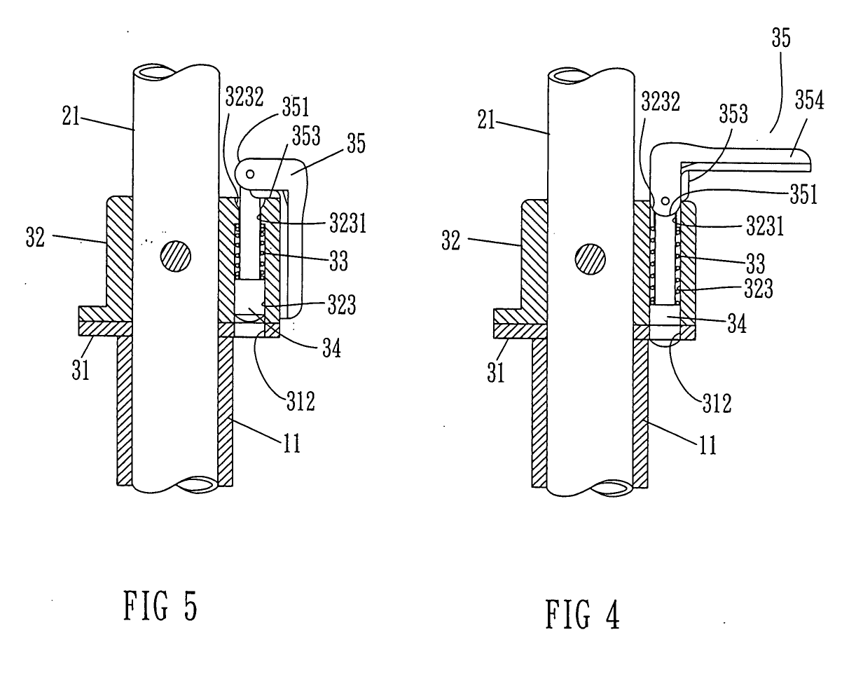

As shown in FIGS. 2 to 5, the lock assembly 30 comprises a lock plate 31, a pin housing 32, a spring 33, a pin 34, and a lever. The lock plate 31 securely attaches on the top end of the sleeve 11 comprises a guide trough 311 and an aperture 312 for receiving a pin 34. The pin housing 32, substantially shaped a cylinder, comprises a screw hole 321 for a screw to secure the pin housing 32 on the front leg 21 when the front leg 21 puts into a sleeve 322 of the pin housing 32, an extension block 324 on the bottom associated with the guide trough 311 of the lock plate 31 for limit the rotation angle of the front legs 21, and a longitudinal bore 323 for a pin 34 and a spring 33 to put into it. A lock end of the pin 34 for inserting to the aperture 312, and the other end insert with the spring into the bore 323, which sets a pivot hole 341 to connect with one end of the lever 35 by a pivot pin 352. The spring 33 sleeves on the pin 34 and insert into the bore 323, therefore, its one end against on an annular raised border 342 of the pin 34 and the other end on the edge 3231 of the bore 323. As shown in FIG. 4, the pin 34 is pushed down by the spring 33. As shown in FIG. 5, the lever 35 lifts the pin 34 up and the spring 33 is in the contraction.

The lever 35, shaping an “L”, comprises a pair of symmetrical extension 351 on the first end with a pin hole 3511 on each to connect with the pivot hole 341 of the pin 34 by the pivot pin 352, a control handle 354 on the second end, and a fulcrum 353 which is a raised flat portion of the middle part. When the pin 34 is in first position, the symmetrical extensions 351 embed into a room 3232 and are stuck by a border of the fulcrum 353. When the control handle 354 is pushed down, the fulcrum 353 holds the lever on this position and lifts up the first end of the level 35, and the pin 34 accordingly lifts up to release the side frame. When the control handle 354 of the lever 35 is lifted up, the pin 34 will be forced down to insert into the aperture 312 by the spring 33 if unfolds the side frame 20 to an operative position.

In alternatively, the leg end of the side frames can set the wheel 22, 25 or a crutch tip on each. If the leg ends set the wheels 22, 25, the holding portion of the side frames 20 set a break handle 24 on each side to control the rear wheel's 22 rolling.

As illustrated in FIGS. 1 and 6, the foldable walker 10 can be easily and conveniently folded or unfolded by an invalid in sitting position. The invalid needs just lifting the seat 14 forward, pushing down the lever 35 and then folding the side frames 20. In open situation, one can lift up the lever 35, unfold the side frames 20 until the respective locking position, and push down the seat 14.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lock assembly for use with a first member concentrically and rotatably mounted in a second member of a foldable walker comprising:
a lock plate secured on one of said first and second members and extending transversely to the longitudinal axes thereof, said lock plate including an aperture adapted to receive a pin when said pin is in its lock position, and a guide trough set for limit rotational angle to another one of said members;
a lock pin positioned substantially parallel to a longitudinal axis of each of said first and second members and located in a external pin housing, said lock pin being movable between a first position in which said first and second members are held in a locked state and a second position in which said members are in an unlocked state such that said first and second members are able to rotate in relation to each other;
a pin housing attached to another of said first and second members to which said lock plate is not secured, said pin housing having a pin room, which can receive a spring and said lock pin, and a extended block in corresponding with said guide trough to limit the rotational angle relatively to each of said members;
a spring sleeved on said lock pin and inserted into said pin housing, for which applies the force to push said lock pin from said second position to said first position;
a lever for moving and holding the lock pin on either said first position or said second position to permit rotation of said first member in relation to said second member or not, said lever having a control handle end, a pin attaching end pivotally connected to said lock pin, and a fulcrum which is a raised flat portion set between said control handle end and said pin attaching end.

2. The lock assembly according to claim 1, wherein said pin housing sets an attaching portion to secure on one of said first and second members.

3. The lock assembly according to claim 1, wherein said lock pin comprises a pivot hole on one end for connect to said level, a lock end on another side for inserting into said aperture of said lock plate, and an raised border next to said lock end against one end of said spring.

4. The lock assembly according to claim 1, wherein said lever sets a pair of symmetrical extension on said pin attaching end with a pin hole on each to connect with said pivot hole of said pin by a pivot pin.

5. The lever according to claim 4, wherein said pin attaching end embeds into said pin room and is stuck by a border of said fulcrum when said lever is lifted up and said pin in first position.

6. The lever according to claim 1, wherein the flat portion of said fulcrum may stand said level and hold said pin in second position when said control handle end of said lever is push down.
